(19) United States
(12) Patent Application Publication
(10) Pub. No.: US 2023/0109795 A1
(43) Pub. Date: Apr. 13, 2023

(54) ROUND INSTRUMENT FOR A VEHICLE

(71) Applicant: Dominic Fritz, Herdecke (DE)

(72) Inventor: Dominic Fritz, Herdecke (DE)

(21) Appl. No.: 17/875,888

(22) Filed: Jul. 28, 2022

(30) Foreign Application Priority Data
Jul. 30, 2021 (DE) 10 2021 119 929.8

(51) Int. Cl. B60K 35/00

(52) U.S. Cl. CPC B60K 35/00; B60K 2370/1515; B60K 2370/152; B60K 2370/5911; B60K 2370/586; B60K 2370/154

(57) ABSTRACT

The invention relates to a round instrument for a vehicle (1), comprising a vehicle interface (3) for transmitting signals (4) between the vehicle (1) and the round instrument (2), comprising an electrical controller (5) for processing at least one signal (4) transmitted from the vehicle (1) to the round instrument (2) via the vehicle interface (3) and for generating at least one piece of vehicle information (6) from the signal (4), comprising a communication interface (7) for communication between the round instrument (2) and a mobile device (8), in particular a smartphone, and comprising a front digital display (9) for displaying the at least one piece of vehicle information (6) and/or a piece of mobile information (10) received from the mobile device (8) via the communication interface (7).

The present invention relates to a round instrument for a vehicle as claimed in claim 1, to a round instrument arrangement as claimed in claim 13, and to a vehicle as claimed in claim 15.

Classic cars in particular usually have round instruments for displaying vehicle information in their dashboards. In most cases, these instruments display the driving speed, the engine speed, and/or the filling level of the fuel tank.

In modern vehicles, these round instruments have given way to digital displays in the instrument cluster. These displays allow the driver to display significantly more information. In modern vehicles, these digital displays not only show the speed and/or engine speed, but also provide the driver with additional information such as navigation information from a navigation system, call information about incoming or outgoing calls, audio information from radio stations being played and/or music tracks currently being played, or the like. Drivers have become increasingly accustomed to this convenience. In this respect, they also desire additional information in the dashboard when driving their classic vehicles.

At the same time, classic car drivers attach particular importance to maintaining the original condition of their classic cars. Since classic cars usually do not have radio slots, or only have small ones, retrofitting a modern infotainment system in the radio slot is usually not a suitable solution. In addition, the radio slots in classic cars are usually located in obscure places and in some cases under the instrument cluster, so that reading a display of an infotainment system installed in the radio slot is usually not possible in these vehicles while driving.

The object of the present invention is thus to provide drivers of older vehicles with additional information in the dashboard without major modifications to the vehicle.

The above object is achieved by means of a round instrument having the features of claim 1.

The basic idea is to replace an analog round instrument usually found in classic cars with an instrument comprising a digital display, and to display the vehicle information and/or mobile information transmitted from a mobile device on said instrument.

Specifically, it is proposed to provide a round instrument for a vehicle comprising a vehicle interface for transmitting signals between the vehicle (as such) and the round instrument.

Said round instrument comprises an electrical controller for processing at least one signal transmitted from the vehicle to the round instrument via the vehicle interface and for generating at least one piece of vehicle information from the signal. Furthermore, a communication interface is provided for communication between the round instrument and a mobile device, in particular a smartphone, as well as a front digital display for displaying the at least one piece of vehicle information and/or a piece of mobile information received from the mobile device via the communication interface. As a result, the driver of the vehicle can be provided with a greater amount of information in the dashboard of the vehicle. In particular, mobile information transmitted via the communication interface can be displayed alternatively or in addition to vehicle information, for example engine speed and/or driving speed. This can be navigation information about the route, and/or audio information relating to played audio data, and/or call information about incoming or outgoing calls on the mobile device, and/or weather information.

If desired, the “look and feel” of the original round instrument can be retained by means of a corresponding digital display, so that the classic look of the classic car is still retained in the dashboard. In addition, it is particularly easy to replace a round instrument in many classic cars without damage. In most cases, the round instruments can simply be removed from the instrument cluster towards the front, and the vehicle interface can be disconnected from the vehicle. A proposed round instrument can then be connected to the vehicle via its vehicle interface and inserted into the instrument cluster. A particularly simple conversion is made possible, which can also be carried out by a non-professional.

A simple configuration of the round instrument or a configuration of the readout on the display of the round instrument itself can be achieved by means of a mobile device via the communication interface (claim 2).

According to the particularly preferred embodiment according to claim 3, the communication interface is a wireless interface, preferably a Bluetooth interface. Such an interface makes it particularly easy to connect the mobile device to the round instrument.

The embodiments according to claims 4 and 5 relate to a preferred configuration of the vehicle interface as well as the processing of an analog signal transmitted via the vehicle interface by means of an analog-to-digital converter.

Claims 6 to 8 describe preferred signals, which are transmitted to the round instrument via the vehicle interface. These signals are preferably evaluated and/or processed, and vehicle information is generated from them, which is displayed on the display of the round instrument.

Claim 9 describes the preferred embodiment of the display as a round display that extends over a substantial portion of the front surface of the round instrument and thus provides the largest possible display surface for information.

Also of interest are the preferred embodiments according to claims 10 and 11, which relate to the physical embodiment of the round instrument, and which enable installation in the instrument cluster of the vehicle that is as simple as possible.

In claim 12, mobile information is designated, which can preferably be displayed digitally on the display of the round instrument.

According to a further teaching that has independent significance, the object described at the outset is further achieved by means of a round instrument arrangement having the features of claim 13.

The round instrument arrangement according to the proposal comprises a first round instrument and a mobile device for communicating with the round instrument via the communication interface and/or another round instrument. For the embodiment of the first round instrument, please refer to the above explanations. The second round instrument is also preferably configured as described above in connection with the first round instrument. By providing two round instruments or the mobile device with digital displays, the display area for information can be further increased. In addition, the same advantages result as described above in connection with the round instrument.

A preferred embodiment of the coupling of the two round instruments using data technology is described in claim 14.

According to a further teaching that has independent significance, the object described at the outset is achieved by means of a vehicle having the features of claim 15.

The vehicle according to the proposal has at least one round instrument of the type described above, and/or a round instrument arrangement of the type described above. The same advantages result as described above in connection with the round instrument or round instrument arrangement.

The present invention will be explained in greater detail below with reference to a drawing depicting only one exemplary embodiment. In the figures:

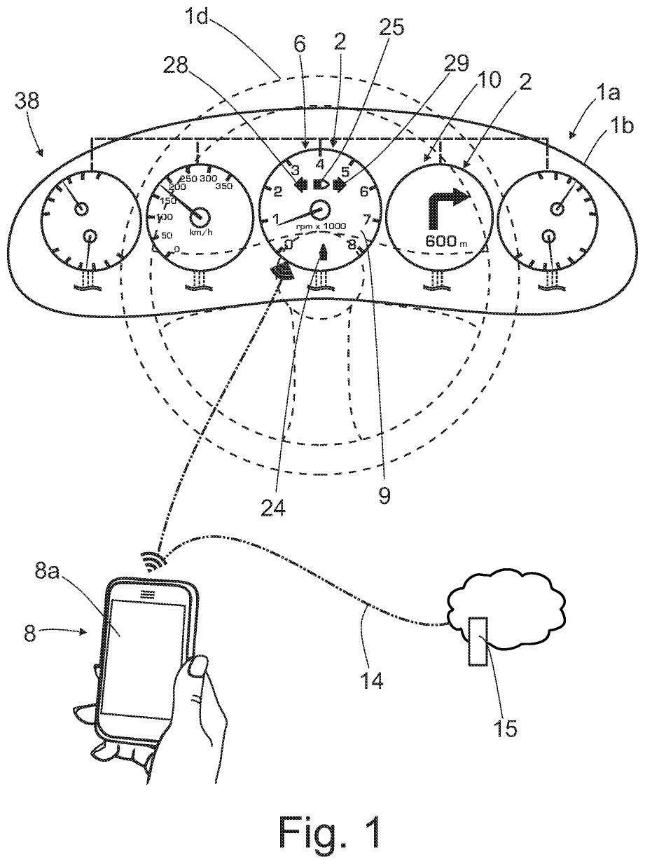

FIG. 1 shows a frontal view of a round instrument arrangement according to the proposal, comprising a proposed round instrument and a mobile device;

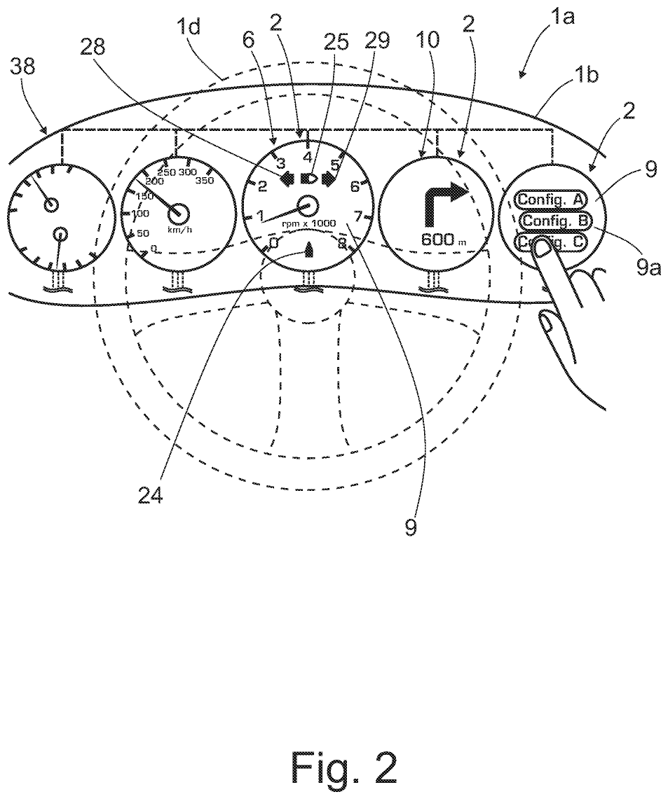

FIG. 2 shows a frontal view of a further exemplary embodiment of a round instrument arrangement according to the proposal, comprising a round instrument according to the proposal;

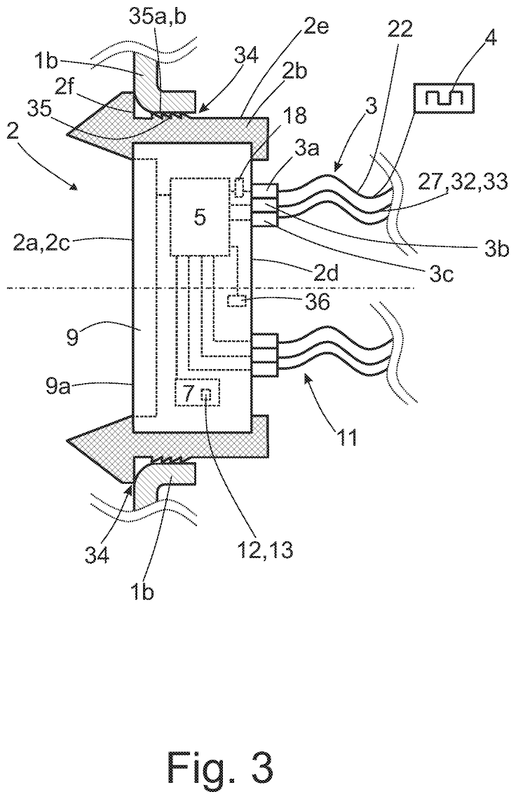

FIG. 3 shows a schematic side view of a round instrument according to the proposal and its attachment in the instrument cluster, and

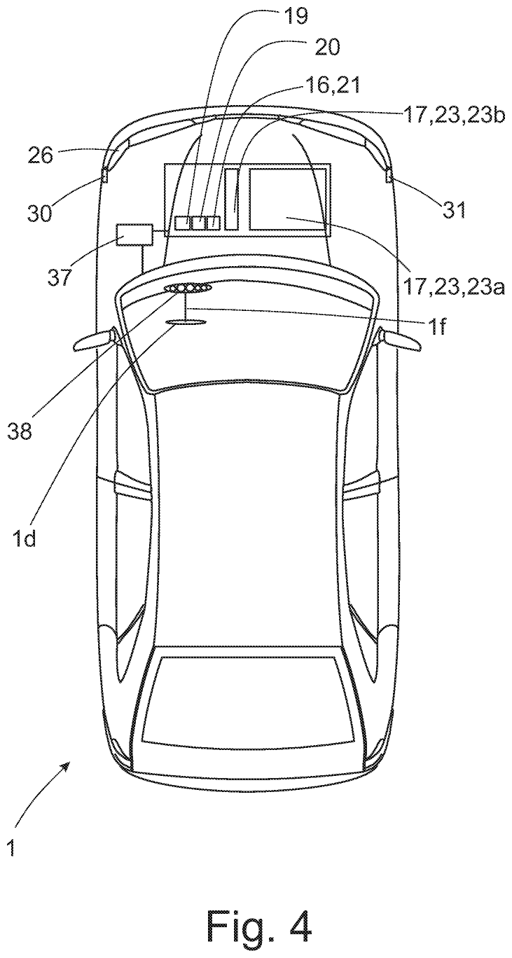

FIG. 4 shows a schematic view of a vehicle according to the proposal, comprising a round instrument arrangement according to the proposal as shown in FIG. 1.

In FIG. 1, several round instruments 2 are shown for a vehicle 1 according to the proposal, at least one of which is configured in accordance with the proposal. Said instrument is arranged here in the dashboard 1a of the vehicle 1 in an instrument cluster 1b.

The round instrument 2 according to the proposal is shown schematically in FIG. 3. It comprises a vehicle interface 3 for transmitting signals 4 between the vehicle 1 (as such) and the round instrument 2. Furthermore, the round instrument 2 has a controller 5 for processing at least one signal 4 transmitted via the vehicle interface 3 and for generating at least one piece of vehicle information 6 from the signal 4. Here and preferably, several different signals 4 are transmitted between the vehicle 1 and the round instrument 2 via the vehicle interface 3. Various kinds of vehicle information 6 are generated here from the various transmitted signals 4. This is done here by evaluating and/or reading out the vehicle information 6 from the respective signals 4 transmitted. If necessary, the signals 4 can also be processed before evaluating and/or reading out the vehicle information 6.

Evaluation means processing the signals to extract the vehicle information. Signals that already directly contain the vehicle information are read out.

Furthermore, the round instrument 2 comprises a communication interface 7 for communication between the round instrument 2 and a mobile device 8. In the exemplary embodiment, the mobile device 8 is a smartphone.

Here, in addition, the round instrument 2 also comprises a front digital display 9 for displaying at least one item of vehicle information 6 and/or one item of mobile information 10 received from the mobile device 8 via the communication interface 7. Various kinds of information can thus be provided to the driver in a particularly simple manner on the digital display 9 in the dashboard 1a while driving.

On the one hand, vehicle information 6 can be displayed that is usually displayed on round instruments 2 of vehicles 1, such as engine speed and/or driving speed. However, in addition or alternatively, mobile information 10 from a mobile device 8 can also be displayed. This information is transmitted here via the communication interface 7. Said information may be, for example, navigation information from the mobile device, and/or audio information from audio data played by means of the mobile device, and/or call information about an incoming or outgoing call on the mobile device.

In addition, the round instrument 2 has a supply interface 11 for supplying with electrical energy. Said interface is preferably provided by the vehicle electrical system 1c of the vehicle 1.

Round instruments 2 in instrument clusters 1b of vehicles 2 are usually arranged in front of the steering wheel 1d in the direction of travel R in such a way that the driver has to reach through or around the steering wheel 1c to make settings on the round instrument 2. Such operation is usually not desirable, at least while driving. Therefore, here and preferably, the round instrument 2, in particular the readout on the display 9 of the round instrument 2 and/or the controller 5 of the round instrument 2, can be configured by means of the mobile device 8 via the communication interface 7. The mobile device 8 can be mounted in a holder outside the steering wheel area and is thus freely accessible. This configurability preferably relates both to the vehicle information 6 to be displayed and to the mobile information 10 to be displayed. In the exemplary embodiment, various configurations for the round instrument 2 can be retrieved from or stored on a remote server 15 via the mobile device 8.

In the exemplary embodiment, the communication interface 7 is a wireless interface. Here and preferably, the round instrument 2 comprises a Bluetooth chip 12, and the communication interface 7 is a Bluetooth interface 13. Here, this is Bluetooth according to Specification 5.2 according to Bluetooth Special Interest Group (SIG). This specification enables particularly simple and secure communication between the round instrument 2 and the mobile device 8.

Furthermore, it may be provided that vehicle information 6 is transmitted from the round instrument 2 to the mobile device 8 via the communication interface 7. This information can then be stored on the mobile device 8 and/or displayed on the display 8a of the mobile device 8. In this way, the display area for information can also be extended from the round instrument 2 to the display 8a of the mobile device 8. Mobile information 10 can also be displayed by the mobile device 8 on the display 9 of the round instrument 2. This information can be downloaded beforehand by the mobile device 8 from remotely located servers 15, for example via the mobile network 14.

The vehicle information 6 can be transmitted from the vehicle 1 to the round instrument 2 in various ways. This is carried out here via the vehicle interface 3. In the exemplary embodiment and preferably, said interface is wired. Alternatively, however, the transmission can also be wireless.

In the exemplary embodiment, the vehicle interface 3 comprises an analog subinterface 3a for transmitting an analog signal 4 from the vehicle 1 to the round instrument 2. In addition or alternatively, a digital sub-interface 3b can be provided for transmitting a digital signal 4 from the vehicle 1 to the round instrument 2. In addition, a further sub-interface 3c can be provided for connecting the round instrument to a bus system 1e of the vehicle 1. Vehicle information 6 from different control units 16 and/or units 17 of the vehicle 1 can be transmitted to the round instrument 2 via a bus system 1d via the same cable or the same cable harness. Such a bus system 1e may for example be a CanBus and/or LinBus and/or Automotive Ethernet.

Here and preferably, the round instrument 2 comprises an analog-to-digital converter 18. Said converter converts an analog signal 4 transmitted via the vehicle interface 3 into a digital signal 4. Said converter prepares the signal 4 for the controller 5. The digital signal 4 is then processed by the controller 5. Said controller evaluates and/or reads the signal 4 (processed here) and generates a piece of vehicle information 6 from the signal 4, which is displayed on the display 9 of the round instrument 2.

For example, the signal 4 can be an analog signal 4 from an ignition distributor 19 or an ignition coil 20, and/or a digital signal 4, in particular a square-wave signal, from an engine control unit 21. From a signal 4 transmitted from the vehicle 1 to the round instrument 2, the controller 5 can generate the engine speed as a piece of vehicle information and display this information on the display 9. Here and preferably, the signal 4 is transmitted directly via a cable 22 without any other signals 4 carrying vehicle information 10 being routed via the same cable 22. This is therefore not a cable of a bus system. Said signal can be transmitted directly from the engine 23, in particular from the engine control unit 21 and/or from the ignition distributor 19 and/or from the ignition coil 20, via a cable 22 to the vehicle interface 3 of the round instrument 2. This cable 22 is connected here and preferably to a sub-interface 3a, 3b of the vehicle interface 3 for the engine 23. The signal 4 is then processed by the round instrument 2, and a piece of vehicle information 6 is displayed on the display 9. In the exemplary embodiment and preferably, the motor speed is displayed on the display 9 as a digital needle display, i.e. a virtual needle. Additionally or alternatively, the engine speed can also be indicated by a physical needle on the digital display 9. In the exemplary embodiment, no further signals 4 that carry vehicle information 10 and that can be displayed on the display 9 can be transmitted via the cable 22 from the engine to the sub-interface 3a, 3b for the engine. This is therefore not a cable of a bus system.

Furthermore, the controller 5 can evaluate the engine speed based on the signal 4 and can display a gear-shifting recommendation 24 on the display 9 based on the engine speed. This can take place, for example, by changing the color of the background of the current display.

Preferably, the engine speed limit range is configurable on the engine speed display and can be set or selected depending on the engine 23 installed in the vehicle 1. This is carried out here and preferably via the mobile device 8 when configuring the display or round instrument 2.

In addition to or alternatively to the engine speed, the control unit 5 can also generate the vehicle speed and/or the boost pressure of the engine 23 as a piece of vehicle information 6 from a signal 4, and display it on the display 9.

Here and preferably, it is further provided that a signal 4 relating to the operating state of the headlight is transmitted via the vehicle interface 3, and the display 9 digitally displays a control symbol 25 relating to the operating state of a headlight 26, such as whether it is switched off or whether the low beam or the high beam is switched on. The transmission of the operating status takes place here and preferably in the form of an analog signal 4 via a cable 27, via which no further vehicle information 6 is transmitted.

Additionally or alternatively, it is provided that a signal 4 relating to the operating state of a turn signal of the vehicle 1 is transmitted via the vehicle interface 3, and that the display 9 digitally displays a control symbol 28, 29 relating to the operating state of the turn signal 30, 31. This is done here for both the left turn signal 30 and the right turn signal 31. The signal 4 here is an analog signal 4 for both the left and right turn signals 30, 31. For the transmission of the signals 4 of the left as well as the right turn signal 30, 31, here and preferably a cable 32, 33 is provided in each case, via which no further vehicle information 6 is transmitted. As can be seen in this exemplary embodiment, the vehicle interface 3 can have multiple ports or sub-interfaces.

As already described, the display 9 of the round instrument 2 is a digital display 9. Said display is configured here as a round display. Said display extends, as shown in FIGS. 1 and 2, over at least 80%, more preferably at least 90%, here and preferably, over at least 95%, of the front surface 2a of the round instrument 2. It is arranged as a full screen in the housing 2b of the round instrument 2. The display is made by means of a grid made up of pixels distributed over at least 80%, more preferably at least 90%, here and preferably over at least 95%, of the front surface 2a of the round instrument 2. In particular it can be designed as a color display and/or have a backlight. Preferably, it is an LCD display or OLED display. Furthermore, the display 9 can have a touch screen 9a for operation. Preferably, however, an input is made by means of the mobile device 8 via the communication interface 7. In particular, no touchscreen may be provided, and/or only configuration and/or operation via the mobile device 8 may be possible.

As can be seen from FIG. 3, the round instrument 2 preferably has a housing 2b, in particular a pot-shaped housing. Here, the display 9 is arranged on a front 2c of the housing 2b, and/or the vehicle interface 3 is arranged on the rear side, here the face 2d. The face diameter of the display 9 is preferably at least 70 mm, more preferably at least 100 mm, more preferably at least 125 mm.

As can be seen from FIG. 3, the round instrument 2 comprises a retaining flange 2f on its circumference 2e, in particular in region B of the front face 2c, for holding the round instrument 2 in the dashboard 1a, in particular in the instrument cluster 1b, of the vehicle 1. Said instrument can be inserted with its rear side first into an opening 34 of the dashboard 1a, here into an opening 34 of the instrument cluster 1b. Said instrument can preferably be positively and/or non-positively fixed in the instrument cluster 1b. The round instrument 2 is held in the dashboard 1a or instrument cluster 1b by means of a rubber rim 35. Said rim has a profile 35a for better holding the round instrument 2 and for damping vibrations. Preferably, said profile comprises several protuberances 35b. The rubber rim 35 preferably extends around the circumference of the round instrument 2. In the exemplary embodiment, said rim is provided in addition to the retaining flange 2f. However, only a retaining flange 2f or only a rubber rim 35 may be provided.

As shown in FIGS. 1 and 2 with reference to another round instrument 2, navigation information from the mobile device 8 can be digitally displayed on the display 9 of the round instrument 2. In addition or alternatively, audio information from audio data played back by means of the mobile device 8 can be digitally displayed on the display 9 of the round instrument 2. In addition, call information about an incoming or outgoing call on the mobile device 8 can be digitally displayed on the display 9 of the round instrument 2. Furthermore, weather information can be displayed digitally on the display 9 of the round instrument 2. In this case, the navigation information and/or audio information and/or call information and/or weather information is mobile information 10 that is transmitted from the mobile device 8 to the round instrument 2 via the communication interface 7.

Preferably, the round instrument 2 uses satellite position determination data (GPS data), which is provided as mobile information 10 from the mobile device 8 via the communication interface 7. However, it may also be provided that a sensor 36 for position determination (GPS sensor) is provided in the round instrument 2, and a speed display and/or a navigation display is provided by means of said sensor.

If the vehicle 1 is a hybrid vehicle, vehicle information 6 relating to a hybrid drive train can also be displayed on the round instrument 2. Then, the vehicle 1 comprises not only one motor 23, but two motors 23, namely an internal combustion engine 23a and an electric motor 23b. Said information may be for example a battery charge status of a battery 37 and/or a power distribution between the electric drive 23b and the internal combustion engine 23a or the like.

Furthermore, FIGS. 1 and 2 show a round instrument arrangement 38 according to the proposal comprising a round instrument 2 according to the proposal, which is formed here and preferably as described above.

The round instrument arrangement 38 further comprises a mobile device 8 for communicating with the round instrument 2 via the communication interface and/or at least one other round instrument 2. The at least one further round instrument 2 is preferably also configured like the round instrument 2 described. In the exemplary embodiment, the round instrument arrangement 38 comprises the mobile device 8 and the further round instrument 2. In addition, further round instruments 2, i.e. in particular a third, fourth and/or fifth round instrument 2, can be provided. Here, the further round instrument 2 or the further round instruments 2 also comprise a vehicle interface 3 and/or a communication interface 7 as well as a front display 9, wherein a piece of information transmitted via the vehicle interface 3 and/or the communication interface 7, in particular vehicle information 6 and/or mobile information 10, can be displayed on the display 9.

In the exemplary embodiment, the first round instrument 2 and the further round instrument 2 or the further round instruments 2 are coupled to each other using data technology, here via their communication interfaces 7. In the exemplary embodiment, this coupling is wireless, but alternatively said instruments can be coupled using data technology via a cable not shown. The round instruments 2 can be configured via the mobile device 8. Here, the round instruments 2 can be configured by the mobile device 8 such that the configuration for the round instruments 2 is transmitted from the mobile device 8 to one of the round instruments 2, and this round instrument 2 transmits the configuration for the further round instrument 2 to this further round instrument 2. This results in a master-slave configuration of the round instruments 2. Communication between the mobile device 8 and the round instruments 2 takes place via one of the round instruments 2 acting as master, and this one master round instrument takes over the distribution of the respective required information to the further round instrument 2 acting as slave or the further round instruments 2 acting as slaves.

As described above, the round instrument 2 or the round instruments 2 are preferably arranged in the instrument cluster 1b of the dashboard 1a of a vehicle 1, as shown in FIG. 4.

Here, the dashboard 1a has a steering column 1f with a steering wheel 1d arranged at its end. The instrument cluster 1b is located in front of the steering wheel 1d in the direction of travel R of the vehicle 1. Said instrument cluster has at least one round instrument 2 of the type described above and/or a round instrument arrangement 38 of the type described above. Here, one of the round instruments 2, in particular the first round instrument 2, is arranged in front of the steering wheel 1d in the direction of travel R, and is concealed by the steering wheel 1d by a projection of said steering wheel along the steering column 1f, as shown by means of the dashed overlay of the steering wheel 1d in FIGS. 1 and 2. Furthermore, a round instrument 2, in particular the further round instrument 2, is arranged in front of the steering wheel 1d in the direction of travel R and is predominantly unconcealed by the steering wheel, preferably at least 80% unconcealed by the steering wheel, by a projection of the steering wheel 1d along the steering column 1f. This is also shown in FIGS. 1 and 2. As a result, said instrument is particularly easy to operate while driving, especially if it has a touchscreen 9a, as shown in FIG. 2. Here, for example, various configurations of the round instrument arrangement 38 can be selected via the touchscreen 9a of the further round instrument 2.

1. A round instrument for a vehicle (1), comprising a vehicle interface (3) for transmitting signals (4) between the vehicle (1) and the round instrument (2), comprising an electrical controller (5) for processing at least one signal (4) transmitted from the vehicle (1) to the round instrument (2) via the vehicle interface (3) and for generating at least one piece of vehicle information (6) from the signal (4),
comprising a communication interface (7) for communication between the round instrument (2) and a mobile device (8), in particular a smartphone, and comprising a front digital display (9) for displaying the at least one piece of vehicle information (6) and/or a piece of mobile information (10) received from the mobile device (8) via the communication interface (7).

2. The round instrument as claimed in claim 1, characterized in that the round instrument (2), in particular the readout of the display (9) of the round instrument (2) and/or the controller (5) of the round instrument (2), can be configured by means of the mobile device (8) via the communication interface (7).

3. The round instrument as claimed in claim 1 or 2, characterized in that the communication interface (7) is a wireless interface, preferably in that the round instrument (2) comprises a Bluetooth chip and the communication interface (7) is a Bluetooth interface.

4. The round instrument as claimed in one of the preceding claims, characterized in that the vehicle interface (3) comprises an analog sub-interface (3a) for transmitting an analog signal (4) and/or a digital sub-interface (3b) for transmitting a digital signal (4), preferably in that a further sub-interface (3c) is provided for connection to a bus system of the vehicle (1).

5. The round instrument as claimed in one of the preceding claims, characterized in that the round instrument (2) comprises an analog-to-digital converter (18) that converts an analog signal (4) transmitted via the vehicle interface (3) into a digital signal (4) from which the controller (5) generates the at least one piece of vehicle information (6).

6. The round instrument as claimed in one of the preceding claims, characterized in that the controller (5) generates the engine speed and/or the vehicle speed and/or the boost pressure of the engine (23) from the signal (4) as vehicle information (6) and displays it on the display (9).

7. The round instrument as claimed in one of the preceding claims, characterized in that the vehicle interface (3) comprises a sub-interface (3a, 3b) to which signals (4) can be transmitted from the engine (23), in particular from the engine control unit (21) and/or from the ignition distributor (19) and/or from an ignition coil (20), via a cable (22), preferably in that no further signals (4) generating vehicle information (6) can be transmitted via the same cable (22) to this subinterface (3a, 3b) and displayed on the display (9).

8. The round instrument as claimed in one of the preceding claims, characterized in that a signal (4) relating to the operating state of a headlight (26) and/or a turn signal (30) of the vehicle (1) can be transmitted via the vehicle interface (3), and the display (9) digitally displays a digital control symbol relating to the operating state of the headlight (26) and/or the turn signal (30, 31) of the vehicle (1).

9. The round instrument as claimed in one of the preceding claims, characterized in that the display (9) is a round display and/or the display (9) extends over at least 80%, more preferably at least 90%, more preferably at least 95%, of the front surface (2a) of the round instrument (2).

10. The round instrument as claimed in one of the preceding claims, characterized in that said instrument comprises a pot-shaped housing (2b), preferably in that the display (9) is arranged on a front face (2c) of the housing (2b) and/or the vehicle interface (3) is arranged on the rear face (2d) of the housing (2b).

11. The round instrument as claimed in one of the preceding claims, characterized in that the round instrument (2) comprises a retaining flange (2f) on its circumference, in particular in the region of the front side, for retaining the round instrument (1) in the dashboard (1a), in particular in the instrument cluster (1b), of the vehicle (1), preferably in that the round instrument (2) can be inserted with its rear side first into an opening (34) in the dashboard (1a), in particular in the instrument cluster (1b), of the vehicle (1).

12. The round instrument as claimed in one of the preceding claims, characterized in that navigation information from the mobile device (8) can be displayed digitally on the display (9) of the round instrument, and/or in that audio information from audio data played by means of the mobile device (8) can be displayed digitally on the display (9) of the round instrument (2), and/or in that call information relating to an incoming or outgoing call on the mobile device (8) can be displayed digitally on the display (9) of the round instrument (2), and/or in that weather information can be displayed digitally on the display (9) of the round instrument (2).

13. A round instrument arrangement comprising a first round instrument (2) that is configured according to one of claims 1 to 12, and comprising a mobile device (8) for communicating with the round instrument (2) via the communication interface (7), and/or comprising at least one further round instrument (2) that is preferably configured as claimed in one of claims 1 to 12.

14. The round instrument arrangement as claimed in claim 13, characterized in that the first round instrument (2) and the at least one further round instrument (2) are coupled to one another using data technology, in particular via their respective communication interface (7), preferably in that the round instruments (2) can be configured via the mobile device (8), more preferably in that the round instruments (2) are configured by the mobile device (8) in such a way that the configuration for the two round instruments (2) is transferred from the mobile device (8) to one of the round instruments (2), and said round instrument transmits the configuration for the further round instrument (2) to said further round instrument.

15. A vehicle with a dashboard (1a), comprising a steering column (1f) with a steering wheel (1d) arranged at the end of the steering column (1f), and comprising an instrument cluster (1b) arranged in front of the steering wheel (1d) in the direction of travel (R) of the vehicle (1), said instrument cluster comprising at least one round instrument (2) as claimed in one of claims 1 to 12, and/or comprising a round instrument arrangement (38) as claimed in one of claim 13 or 14, preferably in that a round instrument (2), in particular the first round instrument (2), is arranged in front of the steering wheel (1d) in the direction of travel (R) and is concealed by the steering wheel (1d) by a projection of said steering wheel along the steering column (1f), and/or a round instrument (2), in particular the further round instrument (2), is arranged in front of the steering wheel (1d) in the direction of travel (R) and is predominantly unconcealed by the steering wheel (1d), preferably 80% uncovered by the steering wheel (1d), by a projection of the steering wheel (1d) in the direction of travel (R).
